(19) United States
(12) Patent Application Publication
(10) Pub. No.: US 2018/0267229 A1
(43) Pub. Date: Sep. 20, 2018

(54) LIGHT GUIDE AND LIGHTING APPARATUS

(71) Applicant: PANASONIC INTELLECTUAL PROPERTY MANAGEMENT CO., LTD., Osaka (JP)

(72) Inventors: Hiroyuki SEKII, Osaka (JP); Shinichi ANAMI, Osaka (JP); Osamu TANAHASHI, Kyoto (JP)

(73) Assignee: PANASONIC INTELLECTUAL PROPERTY MANAGEMENT CO., LTD., Osaka (JP)

(21) Appl. No.: 15/919,827

(22) Filed: Mar. 13, 2018

(30) Foreign Application Priority Data
Mar. 17, 2017 (JP) 2017-053725

(51) Int. Cl. F21V 8/00

(52) U.S. Cl. CPC G02B 6/0061; G02B 6/0068; G02B 6/0085; G02B 6/0036

(57) ABSTRACT

A light guide includes: an incident surface onto which light is emitted; a light exit surface which intersects with the incident surface and from which light is emitted; and a facing surface opposite to the light exit surface. The light guide includes a plurality of clusters of diffusion dots which diffuse light, and the plurality of clusters being regularly arranged at least on the facing surface.

### CROSS REFERENCE TO RELATED APPLICATION

This application claims the benefit of priority of Japanese Patent Application Number 2017-053725 filed on Mar. 17, 2017, the entire content of which is hereby incorporated by reference.

### BACKGROUND

### 1. Technical Field

The present disclosure relates to a light guide and a lighting apparatus including the light guide.

### 2. Description of the Related Art

Conventionally, a light guide sheet (one example of a light guide) including light diffusing layers each including a light diffusing agent and laminated in a dot pattern is disclosed (see, for example, Japanese Unexamined Patent Application Publication No. 2010-177130). This light guide sheet has improved light diffusion properties.

### SUMMARY

However, due to an irregular arrangement of the light diffusing layers on a light exit surface of the light guide, uneveness in luminance occurs in light emitted from the light exit surface of the light guide when the light is emitted from the light exit surface.

In view of the above, an object of the present disclosure is to provide a light guide and a lighting apparatus which can reduce unevenness in luminance of light emitted from a light exit surface of the light guide.

In order to achieve the above-described object, a light guide according to an aspect of the present disclosure includes: an incident surface onto which light is emitted; a light exit surface which intersects with the incident surface and from which light: is emitted; and a facing surface opposite to the light exit surface. The light guide includes a plurality of clusters of diffusion dots which diffuse light, and the plurality of clusters are regularly arranged at least on the facing surface.

In addition, in order to achieve the above-described object, a lighting apparatus according to an aspect of the present disclosure includes the light guide and a light source which emits light onto the incident surface of the light guide.

According to the present disclosure, it is possible to reduce unevenness in luminance of light emitted from a light exit surface of the light guide.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a perspective view which illustrates a lighting apparatus according to Embodiment 1;

(a) in FIG. 2 illustrates a front view of a light guide, etc., and a partially enlarged view of clusters, according to Embodiment 1; (b) in FIG. 2 is a cross-sectional view which illustrates the light guide taken along line IIB-IIB in (a) in FIG. 2, according to Embodiment 1;

(a) in FIG. 3 is a cross-sectional view which illustrates a diffusion dot of the light guide taken along the line III-III in (a) in FIG. 2, according to Embodiment 1; (b) in FIG. 3 is a cross-sectional view which illustrates an example of a diffusion dot of the light guide according to Embodiment 1; (c) FIG. 3 is a cross-sectional view which illustrates a diffusion dot including an undercut portion;

FIG. 4 is a diagram which explains a procedure of arranging the diffusion dots of the light guide according to Embodiment 1;

FIG. 5 is a table indicating an evaluation result regarding unevenness in luminance, light distribution control, and a dotted appearance;

FIG. 6 is a diagram which illustrates a relationship between the total number of diffusion dots included in a cluster and luminance distribution;

FIG. 7 is a diagram which illustrates a relationship between the total number of diffusion dots included in a cluster, unevenness in luminance, and a dotted appearance;

(a) in FIG. 8 illustrates a front view of a light guide, etc., and a partially enlarged view of clusters, according to Embodiment 2; (b) in FIG. 8 is a cross-sectional view which illustrates the light guide taken along line in (a) in FIG. 8, according to Embodiment 2;

FIG. 9 is a diagram which illustrates the arrangement of diffusion dots included in a cluster, a ray-tracing diagram of the cluster, and luminance distribution;

FIG. 10 is a diagram which illustrates a relationship between the density of diffusion dots included in a cluster, unevenness in luminance, and a dotted appearance;

(a) in FIG. 11 illustrates a front view of a light guide, etc., and a partially enlarged view of a cluster, according to Embodiment 3; (b) in FIG. 11 is a cross-sectional view which illustrates the light guide taken along line XIB-XIB in (a) in FIG. 11, according to Embodiment 3;

(a) in FIG. 12 illustrates a front view of a light guide, etc., and a partially enlarged view of a cluster, according to Embodiment 4 (b) in FIG. 12 is a cross-sectional view which illustrates the light guide taken along line XIIB-XIIB in (a) in FIG. 12, according to Embodiment 4;

(a) in FIG. 13 illustrates a front view of a light guide, etc., and a partially enlarged view of a cluster, according to a variation example; (b) in

FIG. 13 is a cross-sectional view which illustrates the light guide taken along line XIIIB-XIIIB in (a) in FIG. 13, according to the variation example;

(a) in FIG. 14 illustrates a front view of a light guide, etc., and a partially enlarged view of a cluster, according to a variation example; (b) in FIG. 14 is a cross-sectional view which illustrates the light guide, taken along line XIVB-XIVB in (a) in FIG. 14, according to the variation example;

(a) in FIG. 15 illustrates a front view of a light guide, etc., and a partially enlarged view of a cluster, according to a variation example; and (b) in FIG. 15 is a cross-sectional view which illustrates the light guide taken along line XVB-XVB in (a) in FIG. 15, according to the variation example.

### DETAILED DESCRIPTION OF THE EMBODIMENTS

Hereinafter, embodiments of the present disclosure will be described with reference to the drawings. It should be noted that the subsequently-described embodiments each show a specific example of the present disclosure. Therefore, numerical values, shapes, materials, structural components, the arrangement and connection of the structural components, etc. shown in the following exemplary embodiments are mere examples, and are not intended to limit the scope of the present disclosure. Furthermore, among the structural components in the following exemplary embodiments, components not recited in the independent claims each of which indicates the broadest concept of the present disclosure are described as arbitrary structural components.

Moreover, “substantially” and “approximately” mean, for example in the case of “substantially the same”, not only exactly the same, but what would be recognized as essentially the same as well,

In addition, each of the diagrams is a schematic diagram and thus is not necessarily strictly illustrated in each of the diagrams, substantially the same structural components are assigned with the same reference signs, and redundant descriptions will be omitted or simplified.

The following describes a light guide and a lighting apparatus according to Embodiment 1 of the present disclosure.

### Embodiment 1

(Configuration)

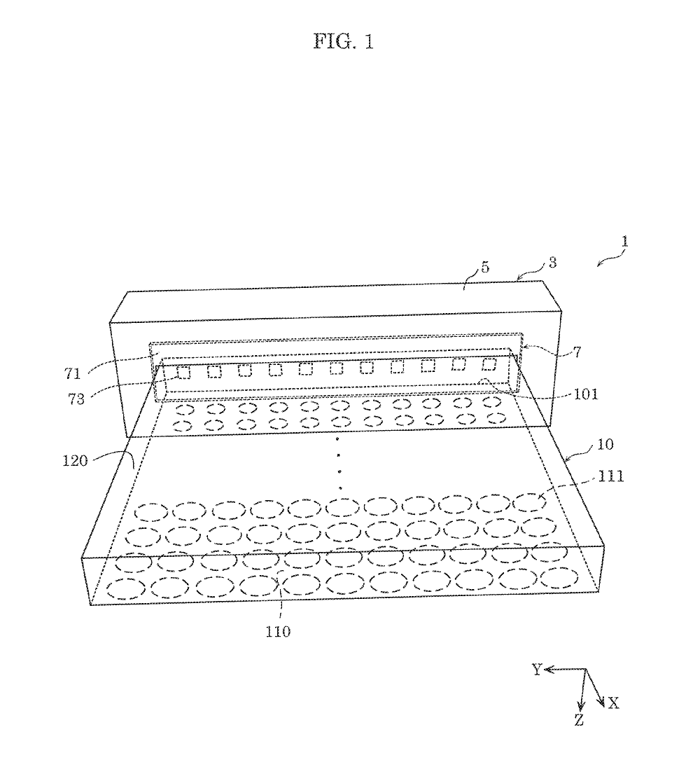

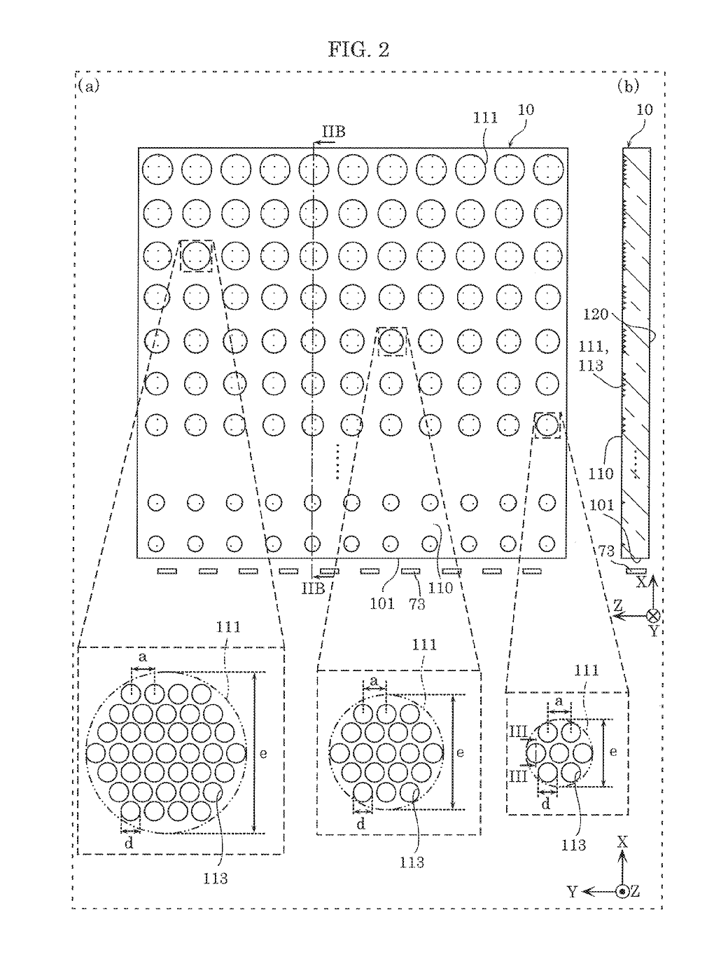

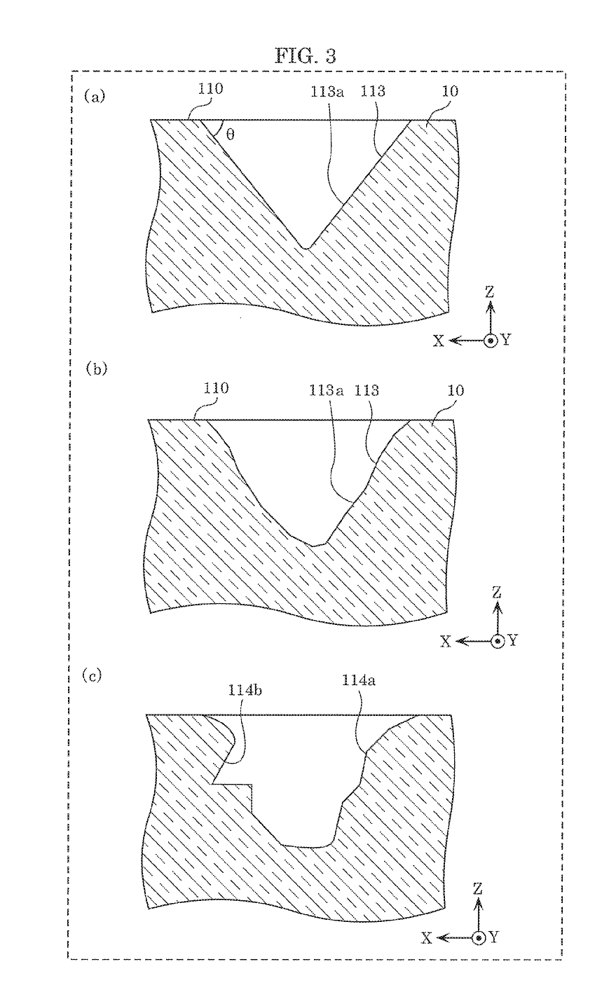

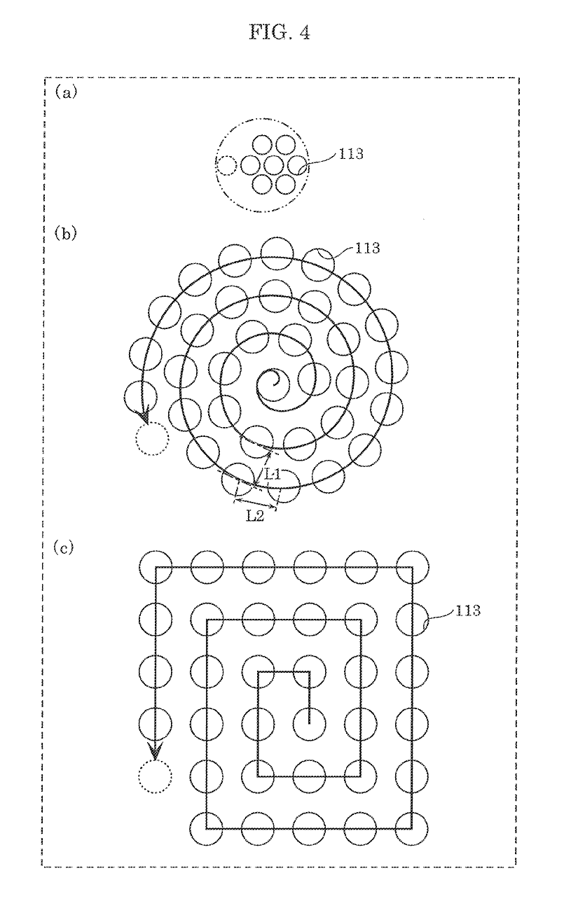

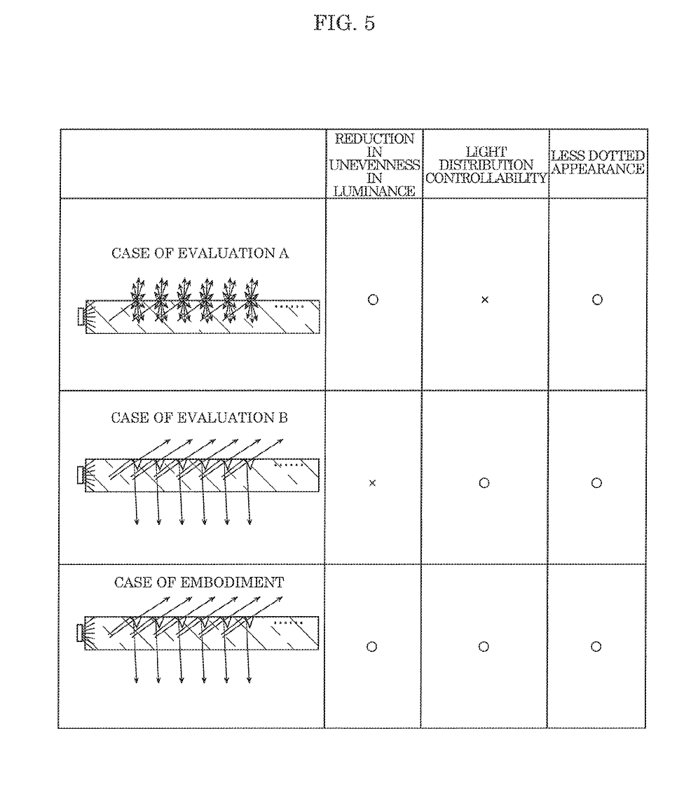

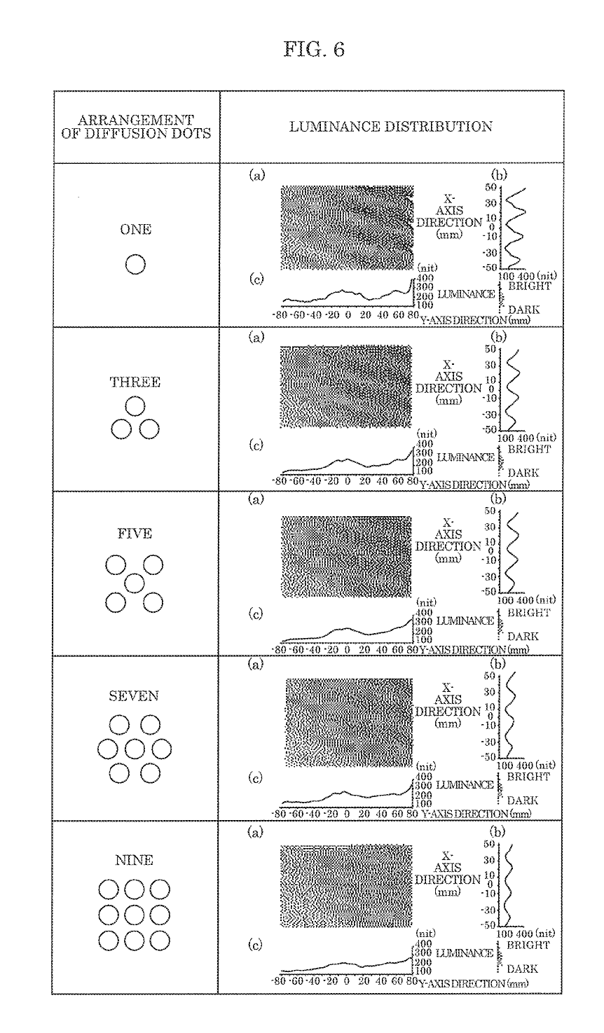

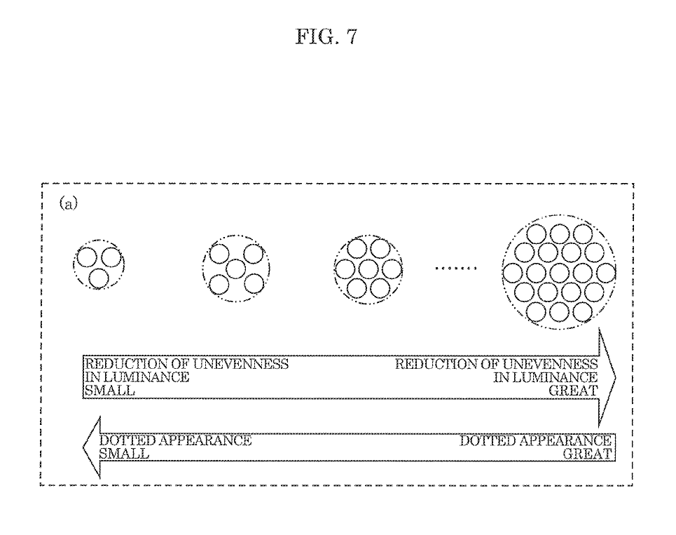

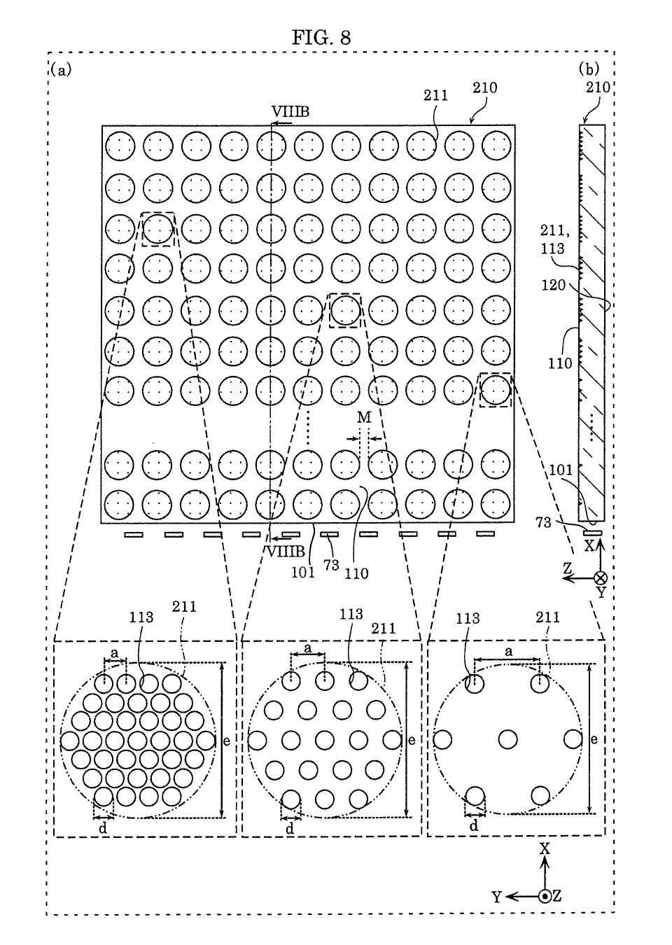

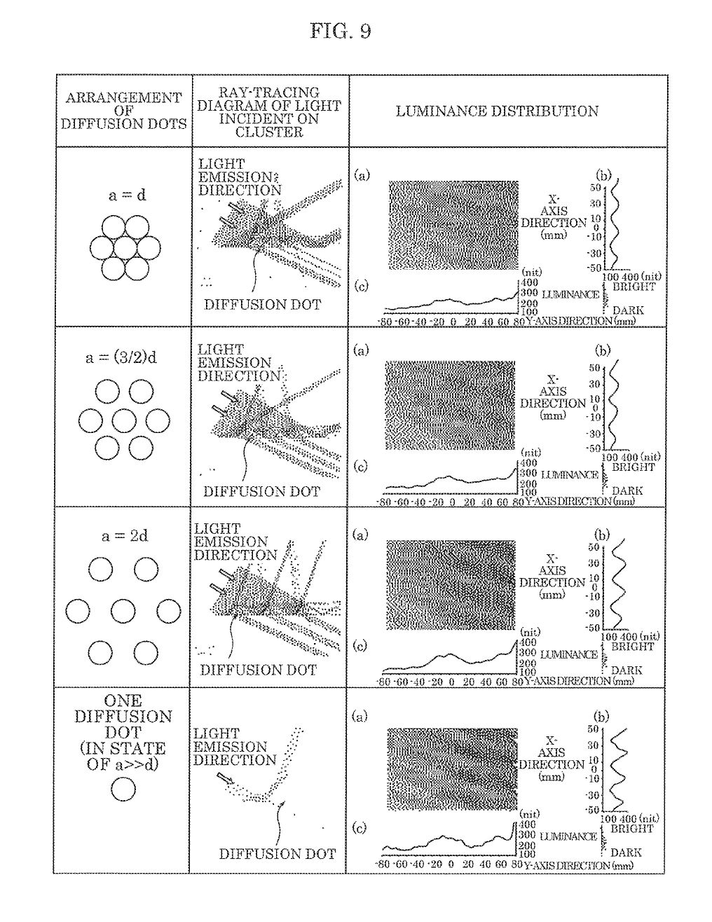

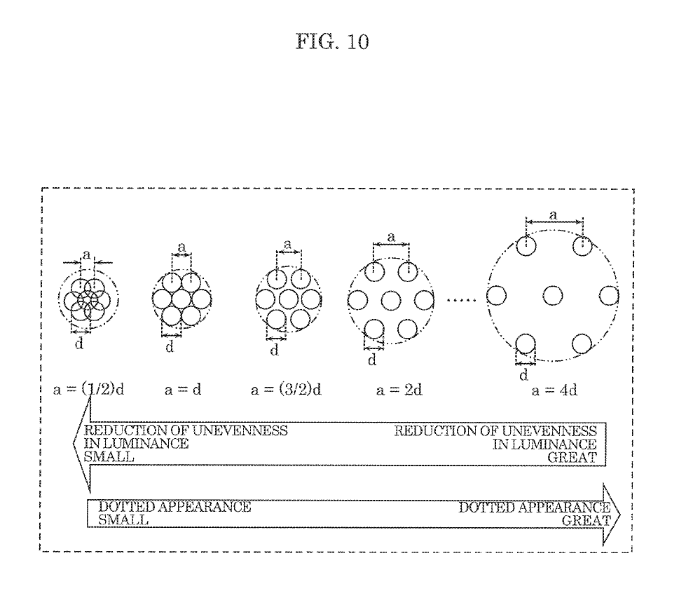

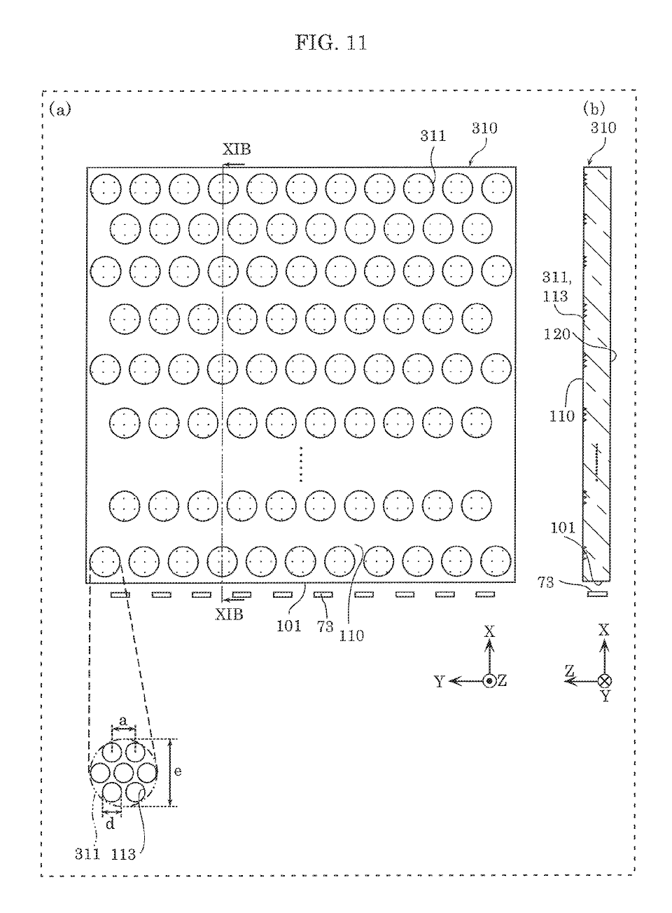

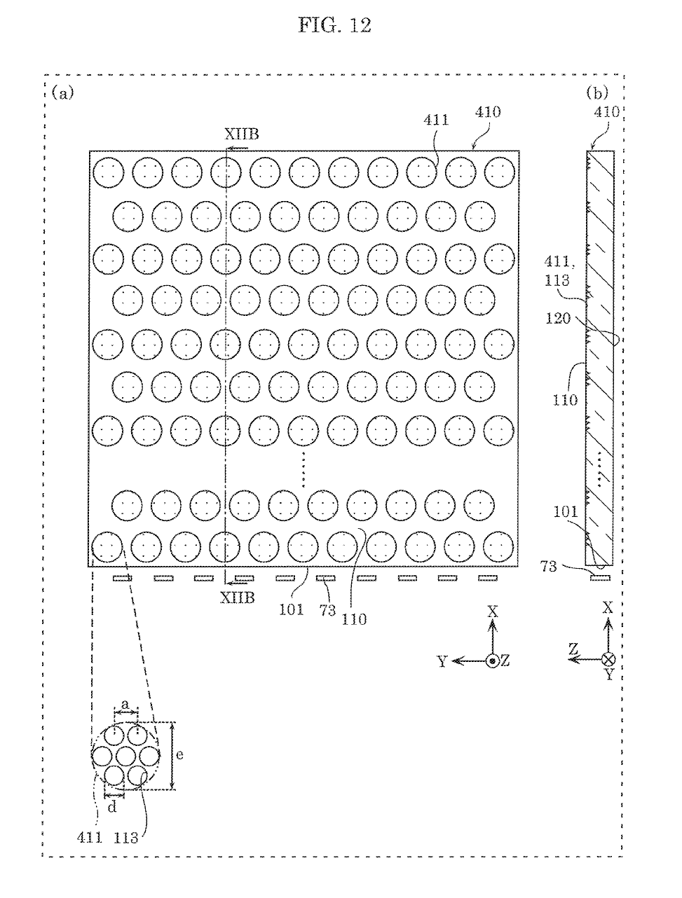

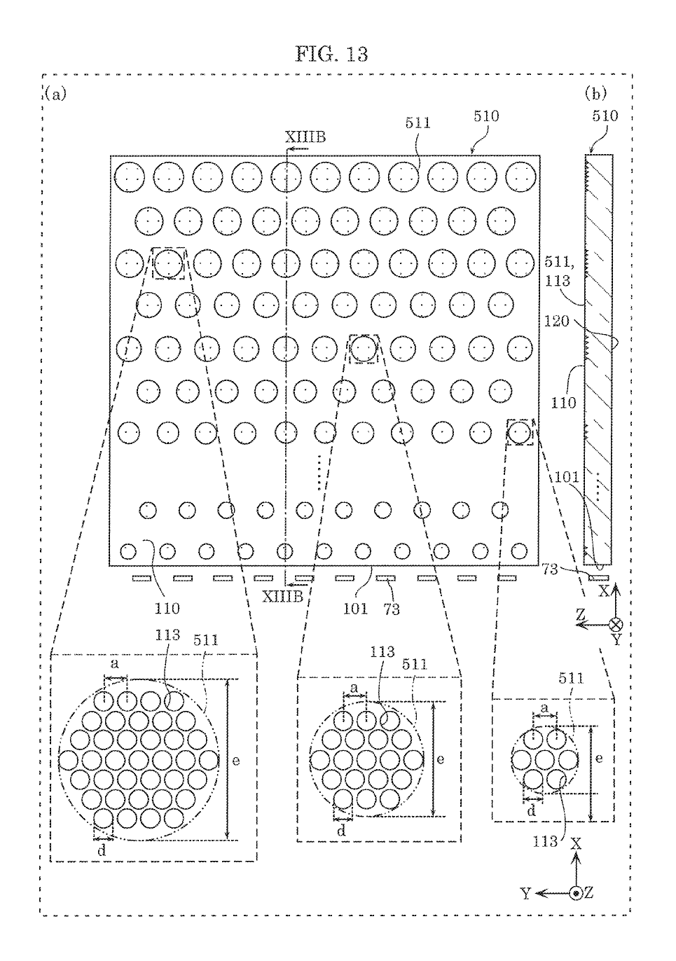

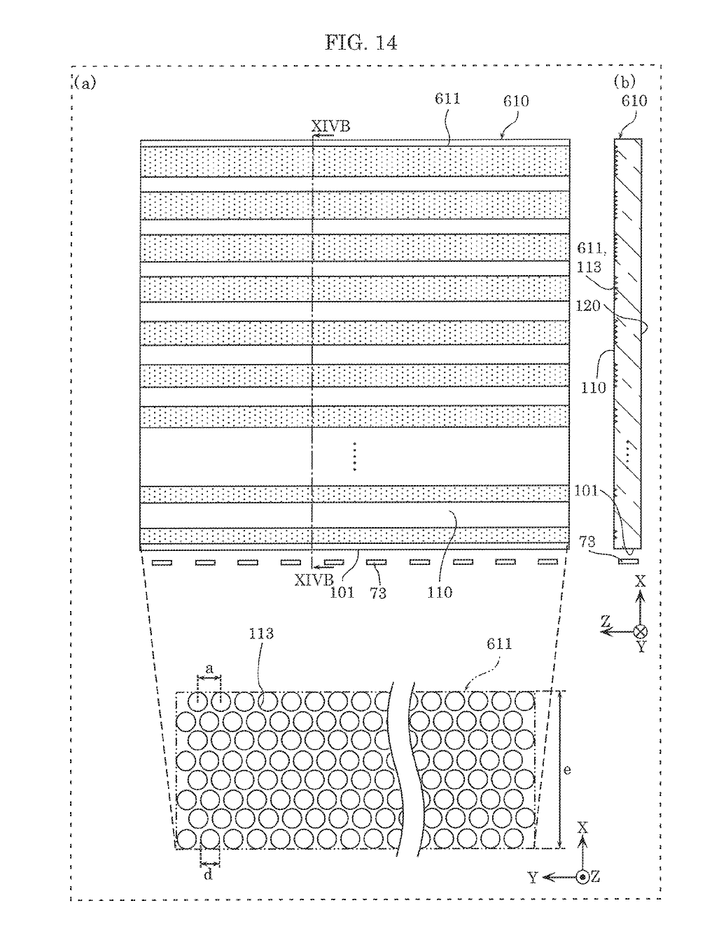

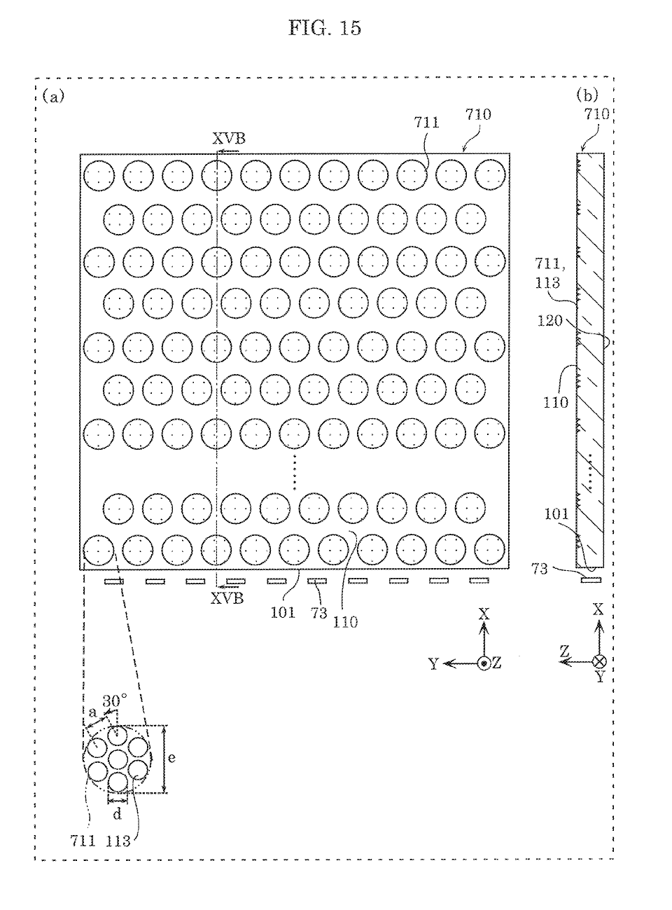

FIG. 1 is a perspective view which illustrates lighting apparatus 1 according to the present embodiment. In FIG. 2, (a) illustrates a front view of light guide 10 and a partially enlarged view of cluster 111, according to the present embodiment. In FIG. 2, (b) is a cross-sectional view which illustrates light guide 10 taken along line IIB-IIB in (a) in FIG. 2, according to the present embodiment. In (a) in FIG. 2, the shape of enlarged cluster 111 is indicated by a virtual two-dot chain line.

Directions of X, Y, and Z are defined as follows: the optical axis direction of light source 73 is defined as X-axis plus direction; the direction from light exit surface 120 toward facing surface 110 that is opposite to light exit surface 120 is defined as Z-axis plus direction; and the direction orthogonal to the X-axis plus direction and the Z-axis plus direction is defined as Y-axis plus direction. It should be noted that the directions illustrated in FIG. 1 correspond to the directions illustrated in FIG. 2. The same applies to all subsequent figures.

Lighting apparatus 1 includes an edge-lit light, guide 10, and is recessed into a part of a structure such as a ceiling and a wall. As illustrated in FIG. 1, lighting apparatus 1 includes main body 3 and light guide 10.

Main body 3 includes casing 5, light emitter 7, and a power supply.

Casing 5 is a box which has a cuboid shape and houses light emitter 7, the power supply including a driving circuit for causing light emitter 7 to emit light, a heat dissipater, etc. Casing 5 supports light guide 10 so as to cause light from light emitter 7 to be incident on light guide 10 in such a manner that a portion of light guide 10 is housed in casing 5. Casing 5 is fixed to the part of a structure by, for example, a bolt or the like.

Light emitter 7 includes substrate 71, and a plurality of light sources 73.

The plurality of light sources 73 are mounted on substrate 71. Substrate 71 is thermally connected to the heat dissipater (heat sink) such that heat generated by the plurality of light sources 73 is dissipated. The heat dissipater may be thermally connected also to casing 5, and casing 5 may also serve as a heat sink. Substrate 71 is electrically connected to the power supply, and supplied with power from the power supply.

According to the present embodiment, substrate 71 has an elongate shape, and the plurality of light sources 73 are mounted on substrate 71 to be aligned in a single line at regular intervals. It should be noted that the plurality of light sources 73 may be aligned in two or more lines on substrate 71.

It should be noted that the heat dissipater may be a metal component (metal support) including, as a main component, a metal material which is high in thermal conductivity, such as aluminum (Al), copper (Cu), iron (Fe), or the like, so as to efficiently dissipate heat generated by the plurality of light sources 73, onto casing 5. In addition, the heat dissipater is not limited to be made of metal, and may be made using a resin material which is high in thermal conductivity.

The plurality of light sources 73 emit light onto incident surface 101 of light guide 10. This means that the plurality of light sources 73 are arranged at substantially regular intervals, such that light is emitted toward the X-axis plus side; that is, an optical axis of each of the plurality of light sources 73 extends in the X-axis plus direction. More specifically, each of the plurality of light sources 73 is disposed to face incident surface 101 of light guide 10 such that the optical axis is substantially orthogonal to incident surface 101. In other words, light guide 10 is disposed on the light exit side (i.e., the X-axis plus side) of the plurality of light sources 73.

In addition, the plurality of light sources 73 and light guide 10 are spaced apart so as to prevent contact between the plurality of light sources 73 and light guide 10. This is for the purpose of preventing heat of the plurality of light sources 73 from conducting to light guide 10 and damaging light guide 10.

The plurality of light sources 73 are each a surface mount device (SMD) LED element. Specifically, the SMD LED element is an LED element of a package-type formed by mounting an LED chip (light emitting element) in a cavity molded by resin, and disposing a phosphor-containing resin in the cavity. The plurality of light sources 73 are turned on or turned off by being controlled by a controller which is included in a power supply and not illustrated. Furthermore, dimming or toning of light emitted from the plurality of light sources 73 is performed as a result of control by the controller which is included in the power supply. For example, a surface mount; device type LED element in which a blue LED chip and a yellow phosphor-containing resin are combined to emit white light is adopted as the plurality of light sources 73.

It should be noted that the plurality of light sources 73 are not limited to the above-described configuration, and a chip on board (COB) light emitting module including an LED chip directly mounted on substrate 71 of the plurality of light sources 73 may be used. In addition, the light emitting element included by each of the plurality of light sources 73 is not limited to an LED, and may be, for example, a semiconductor light emitting element such as a semiconductor laser, or a solid-state light emitting element such as an electro luminescence (EL) element such as an organic EL or an inorganic EL,

The power supply includes a driving circuit for driving light emitter using power from outside, a lead which supplies power for causing light emitter 7 to emit light. The power supply supplies power to light emitter 7 via the lead.

Light guide 10 is an optical component which has a rectangular plate shape, and guides light emitted by the plurality of light sources 73. Light guide 10 is a light transmissive component such as a resin that is, for example, acrylic, polycarbonate, or the like, or glass. However, light guide 10 may be made of any other materials as long as the material is light transmissive. It should be noted that the shape of light guide 10 is not limited to a rectangular shape, and may be any other shapes such as a discotic shape, a multiangular shape, etc.

Light guide 10 has an end fixed in casing 5 on the X axis minus side, and is supported to be substantially parallel to a plane defined by the X-axis direction and the Y-axis direction

As illustrated in FIG. 1 and FIG. 2, light guide 10 includes incident surface 101, light exit surface 120, and facing surface 110.

Incident surface 101 is a surface on which light emitted by each of the plurality of light sources 73 is incident, and is a substantially uniform plane. Incident surface 101 is disposed substantially perpendicular to the optical axis of each of the plurality of light sources 73 such that the light emitted by the plurality of light sources are incident thereon. Incident surface 101 intersects with light exit surface 120 and facing surface 110. It should be noted that incident surface 101 is a portion of a side surface of light guide 10.

Light exit surface 120 is a face of light guide 10 which is positioned on the Z-axis minus side, is substantially orthogonal to incident surface 101, and is a substantially uniform plane.

Facing surface 110 is a face which faces and is opposite to light exit surface 120. Facing surface 110 is a face of light guide 10 which is positioned on the Z-axis plus side, is substantially orthogonal to incident surface 101, and is a substantially uniform plane. In facing surface 110, for example, cluster 111 may emit light to illuminate a part of a structure such as a ceiling.

According to the present embodiment, light exit surface 120 and facing surface 110 are faces through which light guided inside exits. On facing surface 110, a plurality of clusters 111 which are regularly arranged are formed.

The plurality of clusters 111 are arranged in a matrix (in a grid) on facing surface 110. Cluster 111 is a cluster of diffusion dots 113 which diffuse light. Diffusion dots 113 are each a prism which is recessed from facing surface 110 toward light exit surface 120. The prism is, for example, a recessed portion having a shape of a circular cone or a shape of a circular truncated cone. It should he noted that the plurality of clusters 111 may be also formed on light exit surface 120. In this case, light is also emitted from facing surface 110.

At least cluster 111 is disposed between optical axes of two adjacent light sources 73. In other words, an optical axis of at least one light source 73 is positioned between two adjacent clusters 111. It should be noted that a cluster disposed between optical axes of two adjacent light sources 73 may be a portion of cluster 111.

In FIG. 3, (a) is a cross-sectional view which illustrates diffusion dot 113 of light guide 10 taken along the line III-III in (a) in FIG. 2, according to the present embodiment. In FIG. 3, (b) is a cross-sectional view which illustrates an example of diffusion dot 113 of light guide 10 according to the present embodiment. In FIG. 3, (c) is a cross-sectional view which illustrates diffusion dot 114a including undercut portion 114b.

As illustrated in (a) in FIG. 3, in the case where diffusion dot 113 is sectioned by a plane substantially orthogonal to facing surface 110 included in light guide 10, angle θ that is an acute angle between inner circumference surface 113a of diffusion dot 113 and facing surface 110 when diffusion dot 113 is viewed in cross section may be arbitrarily changed. Angle θ is adjusted so as to perform a desired light distribution control.

As illustrated in (a) in FIG. 3 and in (b) in FIG. 3, diffusion dot 113 has a smooth curved recess surface. In other words, inner circumference surface 113a of diffusion clot 113 is a curved recess surface. Arithmetic average roughness of inner circumference surface 113a of diffusion dot 113 is less than or equal to 2 μm. In FIG. 3, (b) is one example of inner circumference surface 113a of diffusion dot 113. Diffusion dot 113 according to the present embodiment does not include undercut portion 114b in diffusion dot 114a as illustrated in (c) in FIG. 3. For that reason, in inner circumference surface 113a of diffusion dot 113, it is possible to ensure mold detachment when forming diffusion dot 113 using a diamond bit or a metallic mold. Thus, light guide 10 is less likely to be damaged when performing mold detachment.

Diffusion dots 113 included in cluster 111 are regularly arranged in cluster 111. When cluster 111 has a circular shape, the diameter is denoted by e. In this case, the diameter of cluster 111 is less than or equal to approximately 300 μm.

According to the present embodiment, diffusion dots 113 are arranged such that space a between adjacent diffusion dots 113 is substantially the same in cluster 111. Diameter d of each of diffusion dots 113 and space a between adjacent diffusion dots 113 among diffusion dots 113 are invariable even when the total number of diffusion dots 113 in cluster 111 differs.

As illustrated in FIG. 2, a space between two adjacent clusters 111 is greater than space a between adjacent diffusion dots 113. For example, in two clusters 111 which are adjacent to each other in the X-axis direction, a distance between (i) diffusion dot 113 disposed outermost in the X-axis plus direction in one of the two clusters 111 (on the X-axis minus side) and (ii) diffusion dot 113 disposed outermost in the X-axis minus direction in the other one of the two clusters (on the X-axis plus side) is greater than space a between adjacent diffusion dots 113.

Coverage of cluster 111 that is calculated by dividing the total area of diffusion dots 113 included in cluster 111 by the area of cluster 111 is less than or equal to 20%. Here, the coverage is calculated by dividing the total area of diffusion dots 113 included in cluster 111 by the area of cluster 111. For example, in the case where cluster 111 has a hexagonal shape, the coverage is calculated by the following expression: coverage=(n(d/2)²)/((3√3a²)/2).

Clusters 111 gradually increase in size with an increase in distance from incident surface 101 of light guide 10 toward a side opposite to incident surface 101 of light guide 10. In other words, diameter e of cluster 111 gradually increases. According to the present embodiment, clusters 111 gradually increase in size in the direction from an end of facing surface, 110 of light guide 10 on the X-axis minus side toward an end of facing surface 110 of light guide 10 on the X-axis plus side. More specifically, the total number of diffusion dots 113 in cluster 111 gradually differs from 7 through 19 to 37, from the side where light sources 73 are disposed toward the X-axis plus side (from the end on the X-axis minus side toward the end on the X-axis plus side). In other words, the total number of diffusion dots 113 differs according to the size of cluster 111. It should be noted that the above-described total number of diffusion dots 113 is one example, and is not limited to this example. Cluster 111 has a circular shape or a multiangular shape. According to the present embodiment, the shape of cluster 111 is based on a circular shape or a hexagonal shape. It should be noted that cluster 111 has a shape which a person recognizes as a circular shape or a multiangular shape when the person views cluster 111, and the diffusion dots need not necessarily be contained within cluster 111.

It should be noted that cluster 111 may be formed of a mixing area where light emitted by two adjacent light sources 73 is mixed inside light guide 10. In this case, when lighting apparatus 1 emits light, light exit surface 120 looks bright due to the light diffused in the mixing area by cluster 111. Accordingly, a sense of discomfort due to uneveness in luminance is less likely to be created.

In lighting apparatus 1 as described above, light emitted by light source 73 is incident on incident surface 101 of light guide 10, and guided in light guide 10. A portion of the light guided in light guide 10 is reflected by diffusion dot 113 in cluster 111, travels to facing surface 110, and exit facing surface 110 to illuminate the periphery of lighting apparatus 1. In addition, a portion of the light which is incident on diffusion dot 113 in cluster 111 is not reflected by diffusion dot 113, and exits diffusion dot 113. This light illuminates, for example, a part of a structure such as a ceiling and a wall.

The total number of diffusion dots 113 is decreased in cluster 111 positioned close to light source 73, and the amount of light emitted from facing surface 110 is reduced. In addition, the total number of diffusion dots 113 is increased in cluster 111 positioned away from light source 73, and the amount of light emitted from facing surface 110 is increased. In this manner, when light is emitted from facing surface 110, light having reduced unevenness in luminance is emitted. More specifically, even when light sources 73 are arranged on substrate 71 at predetermined intervals, it is possible to reduce the contrast between an optical axis of light source 73 and a space between two light sources 73 adjacent to each other, by regularly forming clusters 111 on light guide 10.

(Alignment of Diffusion Dots)

The following describes an order for arranging diffusion dots cluster 111.

FIG. 4 is a diagram which explains a procedure of arranging diffusion dots 113 of light guide 10 according to the present embodiment.

For example, in the case where seven diffusion dots 113 are arranged in cluster 111 as illustrated in (a) in FIG. 4, when the eighth diffusion dot 113 indicated by a dotted line is disposed to be positioned outermost in cluster 111 compared to the seven diffusion dots 113, there is no regularity in the arrangement wherever the eighth diffusion dot 113 is disposed. In this case, there is a possibility that uneveness in luminance occurs in light emitted from light exit surface 120. In view of the above, for example, in the case where clusters 111 gradually increase in size in the direction from an end of the Y-axis minus side toward an end of the Y-axis minus side as illustrated in FIG. 2 of facing surface 110 of light guide 10, diffusion dots 113 in each of clusters 111 are arranged according to Archimedes' spiral as indicated by diffusion dot 113 to be disposed next which is illustrated by a dotted line, as illustrated in (b) in FIG. 4. In this manner, it is possible to cause the shape of each of clusters 111 to have regularity, by regularly arranging diffusion dots 113. By doing so, it is possible to reduce unevenness in luminance of light emitted from the light exit surface.

For example, diffusion dots 113 are arranged such that space L2 between diffusion dots 113 adjacent to each other along a spiral and space L1 between one of diffusion dots 113 and adjacent one of diffusion dots 113 that is positioned inwardly in the spiral is substantially the same in cluster 111.

In addition, the shape of the spiral is not limited to a circular shape. The spiral may have a rectangular shape as illustrated in (c) in FIG. 4, or may have other multiangular shape.

As for the method of manufacturing diffusion dots 113, diffusion dots 113 may be formed by applying silk printing using a light transmissive component such as acrylic, polycarbonate, glass, etc., may be formed by applying laser processing, may be formed using a diamond bit, may be formed by mold injection using a metallic mold, or may be implemented using other known methods, and thus the method of manufacturing diffusion dots 113 is not specifically limited.

(Evaluation Result and Analysis Result)

The following describes evaluation results regarding reduction of unevenness in luminance, light distribution controllability, and appearance (dotted appearance) of diffusion dots 113 in each of the cases where: a dot pattern of an opaque white light diffusion film is formed by silk printing on facing surface 110 of light guide 10 (the case of evaluation A); a general prism is formed on facing surface 110 of light guide 10 (the case of evaluation B); and clusters 111 including a plurality of prisms are regularly arranged.

FIG. 5 is a table indicating an evaluation result regarding unevenness in luminance, light distribution controllability, and dotted appearance.

As illustrated in FIG. 5, in the case of evaluation A, although it possible to reduce the unevenness in luminance by diffusing incident tight using a light diffusion film, light distribution control is not performed as much as the case of evaluation B and the case of the present embodiment. In the case of evaluation B, light distribution control is performed by changing angle θ of the prisms. However, unevenness in luminance occurs depending on the arrangement of the prisms.

In the case of the present embodiment, clusters 111 are arranged regularly on facing surface 110. Accordingly, it is possible to reduce unevenness in luminance and achieve light distribution controllability, and the sense of discomfort is less likely to be created in the appearance (dotted appearance) of diffusion dots 113.

Next, a result of simulation analysis regarding a relationship between the total number of dots and luminance distribution will be described. In this analysis, light guide 10 which is 100 mm×160 mm in size and three light sources 73 are used in causing light from light sources 73 to he incident on incident surface 101.

FIG. 6 is a diagram which illustrates a relationship between the total number of diffusion dots 113 of cluster 111 and luminance distribution.

FIG. 6 illustrates a result of analysis of luminance distribution of light guide 10 in each of the cases where the total number of diffusion dots 113 is one, the total number of diffusion dots 113 is three, the total number of diffusion dots 113 is five, the total number of diffusion dots 113 is seven, and the total number of diffusion dots 113 is nine. In FIG. 6, (a) illustrates luminance distribution of light exit surface 120 of light guide 10, (b) is a graph which indicates luminance of a cross-sectional surface taken along the X-axis direction at a point of 20 mm measured in the Y-axis direction of light guide 10, and (c) is a graph which indicates luminance of a cross-sectional surface taken along the Y-axis direction at a point of 0 mm measured in the X-axis direction of light guide 10.

As indicated by the luminance distributions of (a) and the graphs indicating luminance of (b) and (c), unevenness in luminance is reduced with an increase in the total number of diffusion dots 113. The graphs indicating luminance of (b) show that peaks and valleys in the graphs indicating luminance are alleviated as the total number of diffusion dots 113 is increased.

FIG. 7 is a diagram which illustrates a relationship between the total number of diffusion dots 113 of cluster 111 and the dotted appearance. FIG. 7 is based on the results of FIG. 6.

As illustrated in FIG. 7, the reduction of unevenness in luminance is decreased with a decrease in the total number of diffusion dots 113 in cluster 111, and the sense of discomfort (dotted appearance) is less likely to be created in the appearance of diffusion dots 113. In addition, it is indicated that the reduction of unevenness in luminance is increased with an increase in the total number of diffusion dots 113 in cluster 111, and the sense of discomfort (dotted appearance) is more likely to be created in the appearance of diffusion dots 113.

(Advantageous Effect)

Next, an advantageous effect of light guide 10 and lighting apparatus 1 including light guide 10 according to the present embodiment will be described.

As described above, light guide 10 according to the present embodiment includes incident surface 101 onto which light is emitted; light exit surface 120 which intersects with incident surface 101 and from which light is emitted; and facing surface 110 opposite to light, exit surface 120. Light guide 10 includes a plurality of clusters 111 of diffusion dots 113 which diffuse light, and the plurality of clusters 111 are regularly arranged at least on the facing surface.

As described above, since the plurality of clusters 111 which are regularly arranged are formed on at least facing surface 110, it is possible to reduce the unevenness in luminance of light emitted from light guide 10.

Accordingly, it is possible to reduce unevenness in luminance of light emitted from light exit surface 120 of light guide 10. In addition, also in the case where the plurality of clusters 111 are formed on light exit surface 120 as well, it is possible to reduce unevenness in luminance of light emitted from facing surface 110 of light guide 10.

In particular, even when a user views light guide 10 while light emitter 7 is turned off the sense of discomfort due to the arrangement of clusters 111 is less likely to be created because clusters 111 are regularly arranged. For that reason, the unevenness in luminance on light exit surface 120 and facing surface 110 is reduced even when light emitter 7 emits light, and thus the sense of discomfort due to unevenness in luminance is less likely to be created.

In addition, lighting apparatus 1 according to the present embodiment includes light guide 10 and light source 73 which emits light onto incident surface 101 of light guide 10.

Lighting apparatus 1 which includes light guide 10 also produces advantageous effects the same as or similar to the above-described, advantageous effects.

In addition, in light guide 10 according to the embodiment, diffusion dots 113 are prisms.

According to this configuration, it is possible to easily control light distribution by changing angle θ of prisms.

In addition, in light guide 10 according to the embodiment, the plurality of clusters 111 gradually increase in size with an increase in distance from incident surface 101 of light guide 10 toward a side opposite to incident surface 110 of light guide 10, and the total number of diffusion dots 113 differs according to a size of each of the plurality of clusters 111.

In this manner, since clusters 111 gradually increase in size with an increase in distance from incident surface 101 of light guide 10 toward a side opposite to incident surface 101 of light guide 10, it is possible to further uniform light emitted from light exit surface 120 and facing surface 110.

In addition, in light guide 10 according to the embodiment, diffusion dots 113 each have a smooth curved recess surface.

According to this configuration, since undercut portion 114b as illustrated in (c) in FIG. 3 is less likely to be generated, it is possible to ensure mold detachment when manufacturing light guide 10. Accordingly, light guide 10 is less likely to be damaged when performing mold detachment, and thus it is possible to reduce the decrease in product yield.

In particular, since inner circumference surface 113a of each of diffusion dots 113 in light guide 10 has a smooth curved recess surface, it is possible to easily control light that is reflected by diffusion dot 113.

In addition, in light guide 210 according to the embodiment, the coverage of each of the plurality of clusters 111 which is calculated by dividing a total area of diffusion dots 113 included in cluster 111 by an area of cluster 111 is less than or equal to 20%.

According to this configuration, it is possible to further uniform light emitted from light exit surface 120.

In addition, in light guide 10 according to the embodiment, diffusion dots 113 are regularly arranged in each of the plurality of clusters 111.

According to this configuration, light which is incident on clusters 111 is uniformly reflected easily, and thus it is possible to further uniform light emitted from light exit surface 120.

In addition, in light guide 10 according to the embodiment, diffusion dots 113 in each of the plurality of clusters 111 are arranged according to Archimedes' spiral.

As described above, it is possible to regularly add diffusion dots 113 when clusters 111 are increased in size. Accordingly, it is possible to further reduce unevenness in luminance when light emitter 7 emits light, and the sense of discomfort is less likely to be created in the appearance while light emitter 7 is turned off.

In addition, in light guide 10 according to the embodiment, the plurality of clusters 111 each have one of a circular shape and a multiangular shape.

When cluster 111 has a circular shape or a multiangular shape, the sense of discomfort is less likely to be created in the appearance.

In addition, in lighting apparatus 1 according to the present embodiment, light source 73 comprises a plurality of light sources 73, and at least one of the plurality of clusters 111 is disposed between optical axes of two of the plurality of light sources 73 which are adjacent to each other.

In this manner, since at least cluster 111 is disposed between optical axes of two adjacent light sources 73, it is possible to further reduce unevenness in luminance when light emitter 7 emits light. In particular, this configuration is suitable when light sources 73 emit light of a light bulb color.

In addition, in light guide 10 according to the present embodiment, distance M, illustrated in (a) in FIG. 8, between diffusion dot 113 disposed outermost among diffusion dots 113 in a first cluster 111 among the plurality of clusters 111 and diffusion dot 113 disposed outermost among diffusion dots 113 in a second cluster 111 among the plurality of clusters 111 and adjacent to the first cluster 111 is greater than space L1 or space L2 between adjacent ones of diffusion clots 113 in each of the plurality of clusters 111 illustrated in (b) in FIG. 4.

In addition, in light guide 10 according to the present embodiment, diffusion dots 113 are a prism which is recessed from facing surface 110 toward light exit surface 120 or a prism which is recessed from light exit surface 120 toward facing surface 110.

In addition, in light guide 10 according to the present embodiment, diffusion clots 113 in each of the plurality of clusters 111 are substantially identical in size.

In addition, light guide 10 according to the present embodiment includes: light exit surface 120 from which light is emitted; facing surface 110 opposite to light exit surface 120; and incident surface 101 which is at least a portion of a side surface forming a periphery of light exit surface 120 and facing surface 110, and onto which light is emitted. Light guide 10 includes a plurality of clusters 111 of diffusion dots 113 which diffuse light, and the plurality of clusters 111 are arranged in a grid at least on facing surface 110.

### Embodiment 2

The following describes light guide 210 and a lighting apparatus which includes light guide 210 according to the present embodiment, with reference to FIG. 8.

In FIG. 8, (a) illustrates a front view of light guide 210 etc., and a partially enlarged view of cluster 211., according to Embodiment 2. In FIG. 8, (b) illustrates a cross-sectional view which illustrates light guide 210 according to Embodiment 2, along the line VIIIB-VIIIB of (a) in FIG. 8.

The present embodiment is different from Embodiment 1 in that the densities of diffusions dots 113 in clusters 211 differ while the sizes of clusters 211 are approximately the same.

Light guide 210 and the lighting apparatus including light guide 210 are similar to or same as light guide 10 and lighting apparatus 1 including light guide 10 according to Embodiment 1 in other structural components, and thus the same structural components are assigned with the same reference signs, and detailed descriptions for the structural components will be omitted.

As illustrated in (a) in FIG. 8 and (b) in FIG. 8, the density of diffusion dots 113 in cluster 211 gradually increases, among the plurality of clusters 211, with an increase in distance from incident surface 101 of light guide 210 toward a side opposite to incident surface 101 of light guide 210. The plurality of clusters 211 each have approximately the same diameter e. According to the present embodiment, the density of diffusion dots 113 in cluster 211 gradually increases in the direction from an end of facing surface 110 of light guide 210 on the X-axis minus side toward an end of facing surface 110 of light guide 210 on the X-axis plus side. More specifically, the total number of diffusion dots 113 in cluster 211 gradually differs from 7 through 19 to 37, from the side where light sources 73 are disposed toward the X-axis plus side (from the end on the X-axis minus side toward the end on the X-axis plus side).

When the space between adjacent diffusion dots 113 is defined as a, and the diameter of diffusion dot 113 is defined as d, space a between the adjacent diffusion dots 113 is in a range from 0.5d to 4d. Space a between diffusion dots 113 may be arbitrarily changed according to diameter d of diffusion dot 113, within the above-described range. For example, there are the following cases: a=(1/2); a=d; a=(3/2); a=2d; and a=4d.

(Result of Analysis)

Next, a result of simulation analysis regarding a relationship between the total number of dots and luminance distribution will be described. This analysis is carried out under the same conditions as the conditions indicated in FIG. 6 according to Embodiment 1, and the descriptions for the same conditions will be omitted.

FIG. 9 is a diagram which illustrates the arrangement of diffusion dots 113 included in cluster 211, the ray-tracing diagram of cluster 211, and luminance distribution.

As illustrated in FIG. 9, the ray-tracing diagram shows that light incident on cluster 211 is more regularly reflected with a decrease in density of diffusion dots 113 in cluster 211. In the ease where the density of diffusion clots 113 is the highest; that is, (space a between diffusion dots=diameter d of diffusion dot 113), light reflected in cluster 211 is oriented in various directions. Accordingly, it is shown that the light distribution controllability decreases in the case where a=d. Meanwhile, it is shown that the light distribution control is most easily carried out in the case of a single diffusion dot 113.

As for the luminance distribution, it is shown that, for example, with a decrease in the density of diffusion dots 113, the difference in luminance levels indicated in (b) becomes greater and thus unevenness in luminance increases, leading to a decrease in reduction of unevenness in luminance. Meanwhile, it is shown that, for example, with an increase in the density of diffusion dots 113, the difference in luminance levels indicated in (b) becomes smaller, leading to an increase in reduction of unevenness in luminance.

In view of the above, in order to control light distribution while reducing unevenness in luminance, the case of a=(3/2)d in which the density of diffusion dots 113 in cluster 211 is not too high, and unevenness in luminance is reduced may he employed.

FIG. 10 is a diagram which illustrates a relationship between the density of diffusion dots 113 in cluster 211, unevenness in luminance, and the dotted appearance. In FIG. 10, the following cases are shown as examples: a=(1/2)d; a=d; (3/2)d; a=2d.; and a=4d. FIG. 10 is based on the results of FIG. 9.

As illustrated in FIG. 10, with an increase in density of diffusion dots 113 in cluster 211, the reduction of unevenness in luminance decreases, and the sense of discomfort (dotted appearance) is less likely to be created in the appearance of diffusion dots 113. In addition, with a decrease in density of diffusion dots 113 in cluster 211, the reduction of unevenness in luminance increases, and the sense of discomfort (dotted appearance) is more likely to he created in the appearance of diffusion dots 113.

It should be noted that space a between diffusion dots 113 and diameter d of diffusion dot 113 described here are practical or average numerical values of clusters 211 as a whole on light guide 210, and it is not necessary that space a between diffusion dots 113 and diameter d of diffusion dot 113 are fixed. In addition, since the advantageous effects are not affected even when one or some of clusters 211 do not satisfy the above-described conditions, it is not necessary that all of clusters 211 satisfy the above-described conditions.

(Advantageous Effect)

Next, an advantageous effect of light guide 210 and the lighting apparatus which includes light guide 210 according to the present embodiment will be described.

As described above, in light guide 210 according to the present embodiment, the density of diffusion dots 113 in cluster 211 gradually increases, among the plurality of clusters 211, the density of diffusion dots 113 in each of the plurality of clusters 111 gradually increases with an increase in distance from incident surface 101 of light guide 210 toward a side opposite to incident surface 101 of light guide 210.

In this manner, since the density of diffusion dots 113 in cluster 211 gradually increases with an increase in distance from incident surface 101 of light guide 210 toward a side opposite to incident surface 101 of light guide 210, it is possible to further uniform light emitted from light exit surface 120 and facing surface 110.

In addition, in light guide 210 according to the present embodiment, space a between adjacent ones of diffusion dots 113 is in a range from 0.5d to 4d, where a is a space between adjacent ones of diffusion dots 113 and d is a diameter of each of diffusion dots 113.

In this manner, when space a between diffusion dots 113 is in a range from 0.5d to 4d, certain effects of substantially uniforming light emitted from light exit surface 120 and facing surface 110 are produced.

The present embodiment produces other advantageous effects in the same manner as Embodiment 1.

### Embodiment 3

The following describes light guide 310 according o the present embodiment and a lighting apparatus which includes light guide 310, with reference to FIG. 11.

In FIG. 11, (a) illustrates a front view of light guide 310 etc., and a partially enlarged view of cluster 311, according to the present embodiment. In FIG. 11, (b) is a cross sectional view which illustrates light guide 310 taken along line XIB-XIB in (a) in FIG. 11, according to the present embodiment.

The present embodiment is different from Embodiment 1 in that the density of clusters 311 differs while the sizes of clusters 311 are approximately the same.

Light guide 310 and the lighting apparatus including light guide 310 are similar to or same as light guide 10 and lighting apparatus 1 including light guide 10 according to Embodiment 1 in other structural components, and thus the same structural components are assigned with the same reference signs, and detailed descriptions for the structural components will be omitted.

As illustrated in (a) in FIG. 11 and (b) in FIG. 11, the density of clusters 311 formed on at least facing surface 110 gradually increases with an increase in distance from incident surface 101 of light guide 310 toward a side opposite to incident surface 101 of light guide 310. Diameter e of each of clusters 311 is substantially the same. In addition, the density of diffusion dots 113 in each of clusters 311 is also substantially the same, and seven diffusion dots 113 are included in a single cluster 311.

According to the present embodiment, the density of clusters 311 gradually increases, on facing surface 110 of light guide 310, in the direction from an end of facing surface 110 of light guide 310 on the X-axis minus side toward an end of facing surface 110 of light guide 310 on the X-axis plus side.

(Advantageous Effect)

Next, an advantageous effect of light guide 310 and the lighting apparatus which includes light guide 310 according to the present embodiment will be described.

As described above, on light guide 310 according to the present embodiment, the density of clusters 311 formed on at least facing surface 110 gradually increases with an increase in distance from incident surface 101 of light guide 310 toward a side opposite to incident surface 101 of light guide 310.

In this manner, since the density of clusters 311 gradually increases with an increase in distance from incident surface 101 of light guide 310 toward a side opposite to incident surface 101 of light guide 310, it is possible to further uniform light emitted from light exit surface 120 and facing surface 110.

The present embodiment produces other advantageous effects in the same manner as Embodiment 1.

### Embodiment 4

The following describes light guide 410 according to the present embodiment; and a lighting apparatus which includes light guide 410, with reference to FIG. 12.

In FIG. 12, (a) illustrates a front view of light guide 410 etc., and a partially enlarged view of cluster 411, according to the present embodiment. In FIG. 12, (b) is a cross-sectional view which illustrates light guide 410 taken along line XIIB-XIIB in (a) in FIG. 12, according to the present embodiment.

The present embodiment is different from Embodiment 1 in that the arrangement of clusters 411 differs while the sizes of clusters 411 are approximately the same.

Light guide 410 and the lighting apparatus including light guide 410 are similar to or same as light guide 10 and lighting apparatus 1 including light guide 10 according to Embodiment 1 in other structural components, and thus the same structural components are assigned with the same reference signs, and detailed descriptions for the structural components will be omitted.

As illustrated in FIG. 12, the plurality of clusters 411 are disposed in a staggered arrangement. Diameter e of each of clusters 411 is substantially the same. In addition, the density of diffusion dots 113 in each of clusters 411 is also substantially the same, and seven diffusion dots 113 are included in a single cluster 411.

In addition, in light guide 10 according to the present embodiment, the density of the plurality of clusters 111 formed at least on facing surface 110 is substantially uniform, the plurality of clusters 111 are substantially identical in diameter, and the density of diffusion dots 113 in each of the plurality of clusters 111 is substantially uniform. The present embodiment produces other advantageous effects in the same manner as Embodiment 1.

(Other Variations, Etc.)

Although Embodiments 1 to 4 have been described thus far, the present disclosure is not limited to the above-described embodiments.

For example, (a) in FIG. 13 illustrates a front view of light guide 510 etc., and a partially enlarged view of cluster 511, according to a variation example of the above-described embodiments. In FIG. 13, (b) is a cross-sectional view which illustrates light guide 510 taken along line XIIIB-XIIIB in (a) in FIG. 13, according to the variation example. As illustrated in FIG. 13, the plurality of clusters 511 may be disposed in a staggered arrangement. In addition, (a) in FIG. 14 illustrates a front view of light guide 610 etc., and a partially enlarged view of cluster 611, according to a variation example according a variation example. In FIG. 14, (b) is a.

cross-sectional view which illustrates light guide 610, etc., taken along line XIVB-XIVB in (a) in FIG. 14, according to the variation example. As illustrated in FIG. 14, cluster 611 may have a band shape elongated in the X-axis direction, as one example of the multiangular shape. In FIG. 14, width e of cluster 611 gradually increases with an increase in distance from incident surface 101 toward a side opposite to incident surface 101. In the above-described cases as well, it is possible to reduce unevenness in luminance of light emitted from light exit surface 120 of light guide 610. In FIG. 15, (a) illustrates a front view of light guide 710 etc., and a partially enlarged view of cluster 711, according to a variation example. In FIG. 15, (b) is cross-sectional view which illustrates light guide 710 taken along line XVB-XVB in (a) in FIG. 15, according to the variation example. The example illustrated in FIG. 15 is different from the example illustrated in FIG. 2, etc., in that the arrangement of diffusion dots 113 in cluster 711 is rotated by 30 degrees compared to the example illustrated in FIG. 2, etc. In other words, the arrangement of diffusion dots 113 in cluster 711 is not limited to those described in the above-described embodiments and variation examples, and diffusion dots 113 in cluster 711 may be disposed in any arrangements.

In the light guide according to the present variation, the total number of the diffusion dots in each of the clusters is seven.

In addition, the total number of diffusion dots in a cluster may be the same among all of the plurality of clusters, according to the above-described embodiments. In other words, diameter e of a cluster is substantially the same among the plurality of clusters, the density of the diffusion dots in the cluster is also the same, and the total number of the diffusion dots in the cluster is also the same. In particular, when the total number of the diffusion dots in the cluster is seven, unevenness in luminance is more easily suppressed compared to the case where the total number of the diffusion dots in the cluster is other than seven. In this case, it is possible to reduce unevenness in luminance due to arrangement of the light sources, even when the light sources are disposed at predetermined intervals.

In addition, although the diffusion dots are regularly arranged in the cluster according to the above-described embodiments, the regularity in the arrangement is not indispensable. In other words, the diffusion dots may be arranged randomly in the cluster.

In addition, although the clusters are formed on the light exit surface according to the above-described embodiments, the clusters may be formed on the facing surface, or the clusters may be formed on both the light exit surface and the facing surface.

It should be noted that the present disclosure also includes other forms in which various modifications apparent to those skilled in the art are applied to Embodiments 1 to 4 or forms in which structural components and functions in Embodiments 1 to 4 are arbitrarily combined within the scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A light guide which includes: an incident surface onto which light is emitted; a light exit surface which intersects with the incident surface and from which light is emitted; and a facing surface opposite to the light exit surface, the light guide comprising:
a plurality of clusters of diffusion dots which diffuse light, the plurality of clusters being regularly arranged at least on the facing surface.

2. The light guide according to claim 1, wherein
the diffusion dots are prisms.

3. The light guide according to claim 1, wherein
the plurality of clusters gradually increase in size with an increase distance from the incident surface of the light guide toward a side opposite to the incident surface of the light guide, and
a total number of the diffusion dots differs according to a size of each of the plurality of clusters.

4. The light guide according to claim 1, wherein
a density of the diffusion dots in each of the plurality of clusters gradually increases with an increase in distance from the incident surface of the light guide toward a side opposite to the incident surface of the light guide.

5. The light guide according to claim 1, wherein
a density of the plurality of clusters formed at least on the facing surface gradually increases with an increase in distance from the incident surface of the light guide toward a side opposite to the incident surface of the light guide.

6. The light guide according to claim 1, wherein
space a between adjacent ones of the diffusion dots is in a range from 0.5d to 4d, where a is a space between adjacent ones of the diffusion dots and d is a diameter of each of the diffusion dots.

7. The light guide according to claim 1, wherein
the diffusion dots each have a smooth curved recess surface.

8. The light guide according to claim 1, wherein
a coverage of each of the plurality of clusters which is calculated by dividing a total area of the diffusion dots included in the cluster by an area of the cluster is less than or equal to 20%.

9. The light guide according to claim 1, wherein
the diffusion dots are regularly arranged in each of the plurality of clusters.

10. The light guide according to claim 9, wherein
the diffusion dots in each of the plurality of clusters are arranged according to Archimedes' spiral.

11. The light guide according to claim 1, wherein
the plurality of clusters each have one of a circular shape and a multiangular shape.

12. The light guide according to claim 1, wherein
a distance between a diffusion dot disposed outermost among the diffusion dots in a first cluster among the plurality of clusters and a diffusion dot disposed outermost among the diffusion dots in a second cluster among the plurality of clusters and adjacent to the first cluster is greater than a space between adjacent ones of the diffusion dots in each of the plurality of the clusters.

13. The light guide according to claim 1, wherein
a density of the plurality of clusters formed at least on the facing surface is substantially uniform,
the plurality of clusters are substantially identical in diameter, and
a density of the diffusion dots in each of the plurality of clusters is substantially uniform.

14. The light guide according to claim 1, wherein
a total number of the diffusion dots in each of the plurality of clusters is seven.

15. The light guide according to claim 1, wherein
the diffusion dots are each one of a prism which is recessed from the facing surface toward the light exit surface and a prism which is recessed from the light exit surface toward the facing surface.

16. The light guide according to claim 1, wherein
the diffusion dots in each of the plurality of clusters are substantially identical in size.

17. A light guide which includes: a light exit surface from which light is emitted; a facing surface opposite to the light exit surface; and an incident surface which is at least a portion of a side surface forming a periphery of the light exit surface and the facing surface, and onto which light is emitted, the light guide comprising:
a plurality of clusters of diffusion dots which diffuse light, the plurality of clusters being arranged in a grid at least on the facing surface.

18. A lighting apparatus, comprising:
the light guide according to claim 1; and
a light source which emits light onto the incident surface of the light guide.

19. The lighting apparatus according to claim 18, wherein
the light source comprises a plurality of light sources, and
at least one of the plurality of clusters is disposed between optical axes of two of the plurality of light sources which are adjacent to each other.
